(19) United States
(12) Patent Application Publication
(10) Pub. No.: US 2019/0060822 A1
(43) Pub. Date: Feb. 28, 2019

(54) SURGE TANK DESIGN FOR PRESSURE SWING ADSORPTION PLANTS

(71) Applicant: PRAXAIR TECHNOLOGY, INC., Danbury, CT (US)

(72) Inventors: Arya Ayaskanta, Tonawanda, NY (US); Paul W. Belanger, Clarence Center, NY (US)

(21) Appl. No.: 15/768,986

(22) PCT Filed: Oct. 27, 2016
(86) PCT No.: PCT/US16/59018

§ 371 Date: Apr. 17, 2018

Related U.S. Application Data
(60) Provisional application No. 62/253,373, filed on Nov. 10, 2015.

(51) Int. Cl. B01D 53/04; B01F 5/04; B01F 3/02

(52) U.S. Cl. CPC B01D 53/0446; B01F 2215/0422; B01F 3/02; B01F 5/0475

(57) ABSTRACT

The present invention provides a low cost surge tank design for pressure swing adsorption plants that does not contain internal structures, achieves good mixing and is 15-20% less expensive than the conventional designs. The surge tank is characterized by having a first inlet located in the upper quadrant of said surge tank and a second inlet located in the lower quadrant of said surge tank, wherein said inlets configured to fluidly couple the interior of said surge tank with the exterior of said surge tank; and wherein said first and second inlets are tangentially configured to allow flow to enter said surge tank in diametrically opposite directions.

### RELATED APPLICATIONS

This application claims the benefit of International Application No. PCT/US2016/059018, filed on Oct. 27, 2016, which claimed the benefit of U.S. Provisional Application Ser. No. 61/108,095, filed on Oct. 24, 2008, which are incorporated herein by reference.

### FIELD OF THE INVENTION

The present invention generally relates to a novel surge tank design for pressure swing adsorption plants.

### BACKGROUND OF THE INVENTION

A typical Hydrogen Pressure Swing Adsorption System (PSA) consists of multiple vessels containing adsorbents that selectively adsorb impurities from the feed stream, which usually comes from a steam methane reformer and produce a stream of 99.9% pure hydrogen. The beds are re-generated by a pressure swing during which impurities are desorbed from. The adsorption and desorption of the beds are sequenced to maximize the efficiency of the PSA unit. Hence the pressure and composition of the waste stream is not constant; rather varies during each step of the PSA cycle. This waste stream still contains some heating value and is sent to a surge tank to dampen the pressure and composition fluctuations prior to the gas being sent to fuel the burners of the reformer furnace. It is essential that the fluctuations in the composition of the individual components of the waste gas stream be kept as low as possible to ensure efficient operation of the furnace. This requires fast and efficient mixing within the surge tank.

One way to achieve fast and efficient mixing is to mechanically stir the flow inside the tank using a stirrer. However, this consumes a lot of power and is economically detrimental. Another way, to effect strong mixing is to include internal structures within the vessels which aid in causing strong mixing and thereby reducing the concentration fluctuations. The vessel internals can be quite expensive and so developing a low cost means of achieving near-perfect mixing is desirable.

The present invention provides a low cost surge tank design for pressure swing adsorption plants that does not contain internal structures, achieves good mixing and is 15-20% less expensive than the conventional designs.

### SUMMARY OF THE INVENTION

The present invention generally relates to a surge tank design for improved mixing. The surge tank is characterized by having a first inlet located in the upper quadrant of said surge tank and a second inlet located in the lower quadrant of said surge tank, wherein said inlets configured to fluidly couple the interior of said surge tank with the exterior of said surge tank; and wherein said first and second inlets are tangentially configured to allow flow to enter said surge tank in diametrically opposite directions.

### DETAILED DESCRIPTION OF THE FIGURES

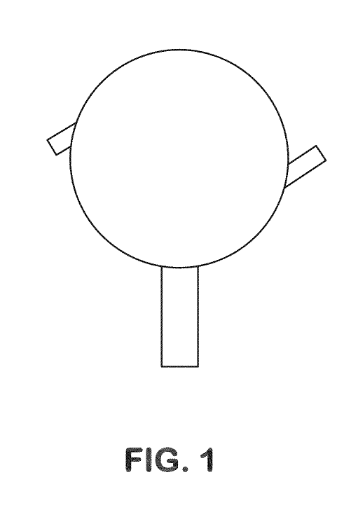

FIG. 1 is a top view of the surge tank design of the present invention.

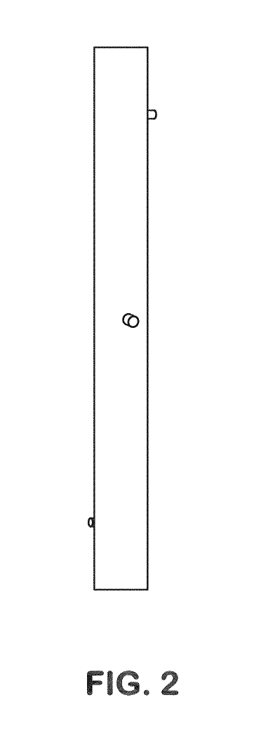

FIG. 2 is a side view of the surge tank design of the invention.

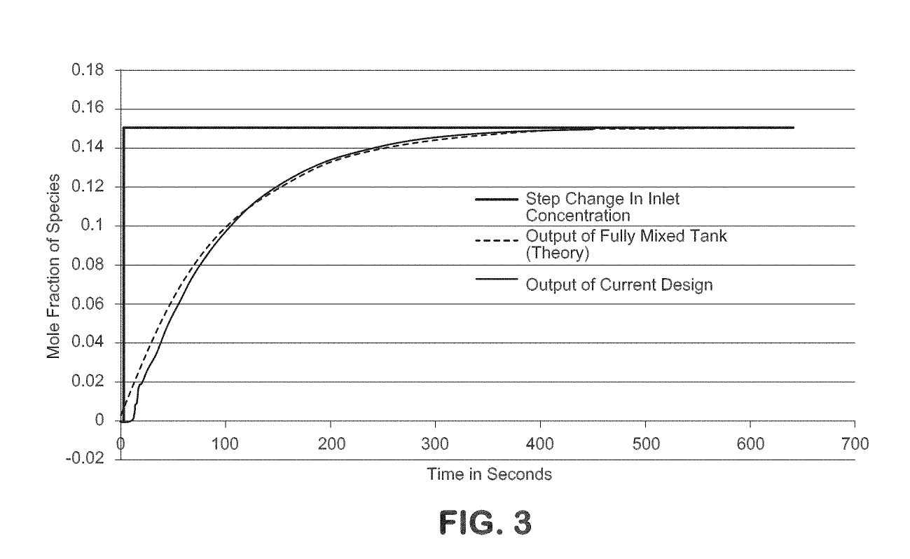

FIG. 3 is a comparison of output response of the surge tank design of the invention to that of a fully mixed tank.

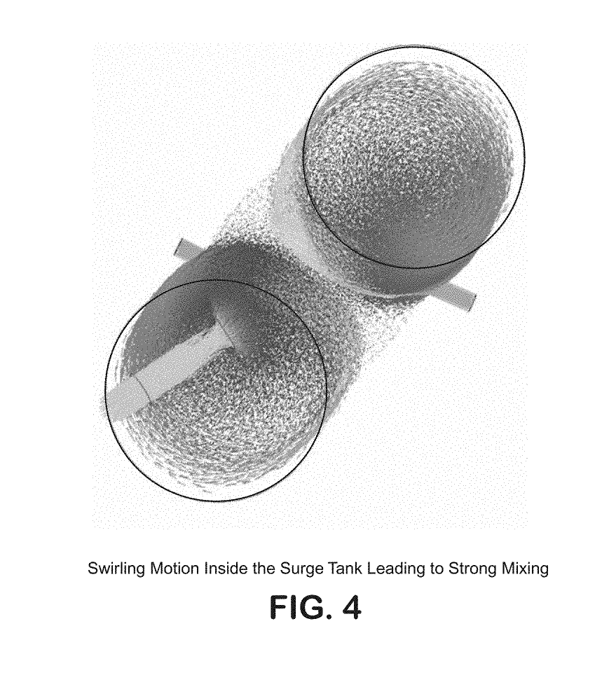

FIG. 4 depicts the swirling motion inside the surge tank leading to strong mixing.

### DETAILED DESCRIPTION OF THE INVENTION

The present invention provides a low cost surge tank design for pressure swing adsorption plants that does not contain internal structures, achieves good mixing and is 15-20% less expensive than the conventional designs. The surge tank of the invention is designed primarily for Hydrogen Pressure Swing Adsorption applications.

The surge tank of the invention can be aligned on an axis that is vertical, horizontal, or on an axis at any angle between vertical and horizontal alignment. The two inlets are located on diametrically opposite ends of the tank, and the vertical, normal and/or straight line separation between the two inlets is from about 5 to about 8 times the diameter of the surge tank. When aligned vertically, the two inlets—one at the top of the tank and one at the bottom, both enter the surge tank tangentially with the vertical when viewed from the top, in diametrically opposite directions. In one embodiment, one inlet is located in the top half of the tank and the other inlet is located in the bottom half of the tank. In another embodiment one inlet is located in the top third of the tank and the other inlet is located in the bottom third of the tank. In yet another embodiment one inlet is located in the upper quadrant of the tank and the other inlet is located in the bottom quadrant of the tank. Regardless of surge tank orientation, the inlets should be on opposite ends of the tank and they should be orientated such that they direct flow in opposite directions.

The surge tank of the invention can also be in horizontal, or approximately horizontal alignment. The two inlets are located on diametrically opposite ends of the tank, and the vertical, normal and/or straight line separation between the two inlets is from about 5 to about 8 times the diameter of the surge tank. When in horizontal alignment the two inlets enter the tank at opposite ends of the tank tangentially with the horizontal when viewed from the side end of the tank. In one embodiment, one inlet is located in the left half of the tank and the other inlet is located in the right half of the tank. In another embodiment one inlet is located in the left third of the tank and the other inlet is located in the right third of the tank. In yet another embodiment one inlet is located in the left quadrant of the tank and the other inlet is located in the right quadrant of the tank. The outlet is typically located at the center of the surge tank, normal to the horizontal diameter of the tank.

Each of said inlets independently enters the surge tank tangentially at an angle of from about 20° to about 40° degrees from the alignment axis directing flow in diametrically opposite directions, in another embodiment 25° to about 35° degrees from the alignment axis directing flow in diametrically opposite directions, and in yet another embodiment approximately 30° degrees from the alignment axis directing flow in diametrically opposite directions.

When in vertical alignment, each of said inlets independently enters the surge tank tangentially at an angle of from about 20° to about 40° directing flow in diametrically opposite directions, in another embodiment 25° to about 35° degrees directing flow in diametrically opposite directions, and in yet another embodiment approximately 30° degrees from the vertical axis directing flow in diametrically opposite directions as viewed from the top of said tank.

When in horizontal alignment each of said inlets independently enters the surge tank tangentially at an angle of from about 20° to about 40° degrees directing flow in diametrically opposite directions; in another embodiment from about 25° to about 35° degrees directing flow in diametrically opposite directions; and in yet another embodiment approximately 30° degrees from the horizontal directing flow in diametrically opposite directions when viewed from the side end of said tank. By orientating the inlets in this fashion the flow enters the two inlets tangentially and swirls in opposite directions before exiting through the outlet. This leads to intense mixing without the need of complicated and expensive internal structures.

The outlet of the surge tank is generally located in the center of the tank, normal to the horizontal diameter of the tank (see FIGS. 1 and 2 for orientation), although it can be located in virtually any quadrant of the tank depending on design requirements. Flow enters through the two inlets tangentially and swirls in opposite directions before exiting through the outlet. This leads to intense mixing, resulting in the surge tank's mixing effectiveness closely resembling that of a perfectly mixed tank.

In one embodiment, the surge tank of the invention is in vertical alignment and comprises:
a side wall comprising an inner and outer surface;
a top of the surge tank and a bottom of the surge tank each coupled to said side wall wherein the top, bottom and side wall define the interior and exterior of said surge tank;
a first inlet located in the upper section of said surge tank and a second inlet located in the lower section of said surge tank, said inlets configured to fluidly couple the interior of said surge tank with the exterior of said surge tank; and
at least one outlet configured to fluidly couple said interior and exterior of said surge tank. The first and second inlets are tangentially configured to allow flow to enter said surge tank in diametrically opposite directions such that they direct flow in opposite directions.

In another embodiment, the surge tank of the invention is in horizontal alignment and comprises:
a side wall comprising an inner and outer surface;
a left side of the surge tank and a right of the surge tank each coupled to said side wall wherein the left, right and side wall define the interior and exterior of said surge tank;
a first inlet located in the left hand section of said surge tank and a second inlet located in the right hand section of said surge tank, said inlets configured to fluidly couple the interior of said surge tank with the exterior of said surge tank; and
at least one outlet configured to fluidly couple said interior and exterior of said surge tank. The first and second inlets are tangentially configured to allow flow to enter said surge tank in diametrically opposite directions such that they direct flow in opposite directions.

In another embodiment, the surge tank of the invention has two inlets, one in the top quadrant of the tank and one in the bottom quadrant of the tank, each entering the tank tangentially with the vertical when viewed from the top, and configured to face in diametrically opposite directions, such that the flow is introduced and directed in opposite directions. The two inlets enter tangentially to the tank, at an angle of approximately 30° from the vertical looking down from the top of the tank. The two inlets are located on diametrically opposite ends of the tank, and the vertical, normal and/or straight line separation between the two inlets is from about 5 to about 8 times the diameter of the surge tank. The outlet is located at the center of the surge tank, normal to the horizontal diameter of the tank.

In order to demonstrate how close the mixing effectiveness of this new design is to that of a perfectly mixed tank, a step change is introduced in the concentration of one of the components of the feed stream and the output response of the surge tank is obtained using Computational Fluid Dynamics (CFD) modeling. The output response of a perfectly mixed tank is given by:

$$\frac{\partial {X}_{out}}{\partial t} = \frac{{X}_{in} - {X}_{out}}{τ}$$

where:
X=Mole fraction of the species concerned
τ=Residence time of the species within the tank (for a gas mixing tank at low and roughly constant pressure the time constant is tank volume divided by volumetric flow of the inlet and outlet streams)

This output response of the simulated surge tank is compared to the response of a perfectly mixed tank and is shown in FIG. 3. It can be seen that the two responses overlap and hence this new design closely resembles a fully mixed tank.

Prior designs employ internal structures within the surge tank or other reactor vessels to cause efficient mixing. These internal structures increase the complexity of fabrication and also add to the costs of the surge tank. U.S. Pat. No. 5,156,458 for example uses a series of baffles to introduce back-mixing and dampen the concentration fluctuations of the individual components of the feed stream. U.S. Pat. No. 4,313,680 uses a plurality of flow converging and deflecting elements within a reactor vessel to effect rapid mixing. While these designs may cause strong and efficient fluid mixing, the internal structures described within these inventions dramatically increase the complexity and cost of the vessel and may also cause higher pressure drops.

The present invention has no internal structures and hence presents a more economical and simple option. It is surprising and unexpected that the surge tank design of the invention achieves near perfect mixing despite not having internal structures within the vessel. The absence of internal structures in the surge tank design of the invention reduces complexity and fabrication costs, and also leads to less pressure drop within the vessel.

It will be appreciated that the invention is not restricted to the details described above with reference to preferred embodiments and that numerous modifications and variations can be made without departing from the spirit and scope of the invention as defined in the following claims.

We claim:

1. A surge tank comprising at least a first and a second inlet configured to fluidly couple the interior of said surge tank with the exterior of said surge tank; wherein said first and second inlets are located at opposite ends of said surge tank and each of said inlets independently enters said surge tank tangentially in diametrically opposite directions such that they direct flow in opposite directions.

2. The surge tank of claim 1 wherein said surge tank is aligned on a vertical axis, on a horizontal axis, or on any axis between the vertical and horizontal axis.

3. The surge tank of claim 2 wherein each of said inlets is tangentially angled from about 20° to about 40° degrees from the alignment axis of said surge tank.

4. The surge tank of claim 3 wherein each of said inlets is tangentially angled from about 25° to about 35° degrees from the alignment axis of said surge tank.

5. The surge tank of claim 4 wherein each of said inlets is tangentially angled approximately 30° degrees from the alignment axis of said surge tank.

6. The surge tank of claim 1 wherein the straight line separation between the two inlets is from about 5 to about 8 times the diameter of the surge tank.

7. A surge tank comprising:
a side wall comprising an inner and outer surface;
a top of the surge tank and a bottom of the surge tank each coupled to said side wall wherein the top, bottom and side wall define the interior and exterior of said surge tank;
a first inlet located in the upper quadrant of said surge tank and a second inlet located in the lower quadrant of said surge tank, said inlets configured to fluidly couple the interior of said surge tank with the exterior of said surge tank; and
at least one outlet configured to fluidly couple said interior and exterior of said surge tank;
wherein said first and second inlets are tangentially configured to allow flow to enter said surge tank in diametrically opposite directions such that they direct flow in opposite directions.

8. The surge tank of claim 7 wherein each of said inlets independently enters said surge tank tangentially at an angle of from about 20° to about 40° degrees with the vertical when viewed from the top of said tank.

9. The surge tank of claim 8 wherein each of said inlets enter said surge tank tangentially at an angle of 25° to about 35° degrees with the vertical when viewed from the top of said tank.

10. The surge tank of claim 9 wherein each of said inlets enter said surge tank tangentially at an angle of approximately 30° degrees with the vertical when viewed from the top of said tank.

11. The surge tank of claim 7 wherein the outlet of the surge tank is located in the center of the tank, normal to the horizontal diameter of the tank.

12. The surge tank of claim 7 wherein the straight line separation between the two inlets is from about 5 to about 8 times the diameter of the surge tank.

13. A surge tank comprising:
a side wall comprising an inner and outer surface;
a left side of the surge tank and a right of the surge tank each coupled to said side wall wherein the left, right and side wall define the interior and exterior of said surge tank;
a first inlet located in the left hand section of said surge tank and a second inlet located in the right hand section of said surge tank, said inlets configured to fluidly couple the interior of said surge tank with the exterior of said surge tank; and
at least one outlet configured to fluidly couple said interior and exterior of said surge tank, wherein said first and second inlets are tangentially configured to allow flow to enter said surge tank in diametrically opposite directions such that they direct flow in opposite directions.

14. The surge tank of claim 13 wherein each of said inlets independently enters said surge tank tangentially at an angle of from about 20° to about 40° degrees with the horizontal when viewed from the end of said tank.

15. The surge tank of claim 14 wherein each of said inlets enter said surge tank tangentially at an angle of 25° to about 35° degrees with the horizontal when viewed from the end of said tank.

16. The surge tank of claim 15 wherein each of said inlets enter said surge tank tangentially at an angle of approximately 30° degrees from horizontal when viewed from the end of said tank.

17. The surge tank of claim 13 wherein the straight line separation between the two inlets is from about 5 to about 8 times the diameter of the surge tank.
